(19) United States
(12) Patent Application Publication
(10) Pub. No.: US 2007/0112650 A1
(43) Pub. Date: May 17, 2007

(54) Entry of invoice before goods receipt

(76) Inventors: Benjamin Klehr, Rastatt (DE); Tanja Sohngen, Altlussheim (DE); Paola Sala, Heidelberg (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/255,959

(22) Filed: Oct. 24, 2005

(51) Int. Cl. G06Q 10/00

(52) U.S. Cl. 705/28

(57) ABSTRACT

Systems and methods are disclosed for suggesting item information for an invoice based on information in a related purchase order and/or goods receipt. Consistent with the principles of the invention, the procurement management system, upon initiation of an invoice entry, may search for a related purchase order and may determine whether any of the one or more items in the related purchase order have corresponding goods receipts. For those items in the related purchase order that are missing their expected goods receipts, the procurement management system may suggest item information obtained exclusively from the related purchase order. For those marked items that have been determined as having corresponding goods receipts, the procurement management system may obtain and verify information associated with these items from and against both the related purchase order and the items' corresponding goods receipts.

### DESCRIPTION OF THE INVENTION

1. Field of the Invention

The field of the invention relates generally to invoice processing in a procurement management system. More specifically, the field of the invention relates to suggesting item data for an invoice based on item data in a related purchase order and/or goods receipt in a procurement management system.

2. Background of the Invention

An invoice is a document that sets forth an invoice recipient's obligations to a vendor or service provider. Typically, the obligations set forth in the invoice arise from a previously issued purchase order, which requests goods or services from the vendor or service provider. Upon the receipt or completion of the requested goods or services, a goods receipt or equivalent confirmation is generated. Creation of the invoice typically follows the acknowledgement of the goods receipt or equivalent confirmation.

An invoice may contain both general invoice information and detailed item information. General invoice information may include, for example, total amounts, total taxes, freight costs, vendor details, invoice recipient information, and any other suitable information. Detailed item information may include item names, descriptions, quantities, and any other suitable item information. To ensure the accuracy and consistency of the item information in the invoice, the procurement management system may verify the item information in the invoice against corresponding information in one or more related purchase orders and/or goods receipts.

Current invoice processing schemes generally do not allow posting of the invoice for financial processing unless information in the invoice has been successfully verified against information in one or more related purchase orders and/or goods receipts. Even in situations where such verification is not required or otherwise waived, for example, by an authorized user, the invoice may still be prevented from being posted for financial processing if a goods receipt expected in connection with, for example, an item of the invoice, is yet to be received or otherwise acknowledged.

Many procurement-related activities, including invoice processing, are now being carried out by specialized procurement management systems. When processing an invoice, a procurement management system generally follows the paper-based processing paradigm described above. However, in order to simplify the process of invoice post prevention, for example, in the situation where a goods receipt expected in connection with an item of the invoice does not exist, a current procurement management system typically implements the rigid rule of preventing entry of the item or even the entire invoice.

While the above blanket prevention achieves the goal of preventing posting of an invoice when an item in the invoice is missing a corresponding expected goods receipt, it is an overly rigid means to achieve that goal. For example, the above rule completely excludes the possibility of allowing the user to create an invoice having items that are missing their corresponding goods receipts and maintaining these items in the procurement management system without posting, for example, while awaiting the acknowledgement of the corresponding goods receipts.

FIG. 1 shows a flowchart of invoice entry in a known procurement management system. At stage 102, the procurement management system may allow a user to initiate entry of an invoice. The user may request invoice entry, for example, by invoking an invoice entry option in one or more interfaces. As an example, the invoice entry option may be an option to search for a related purchase order, based on which some information for the invoice entry may be selected or generated.

At stage 104, the procurement management system may determine that a purchase order related to the invoice, or more specifically, one or more items in the purchase order, are marked items, which are expecting corresponding goods receipts or equivalent confirmations. In the known procurement management system, items in the purchase order may become marked as expecting goods receipts at the time that the purchase order is entered. An example of marking items of a purchase order for goods receipt is shown in FIG. 3, which will be described in more detail below. As illustrated in FIG. 3, individual items of the purchase order may be separately marked for separate goods receipts.

Upon determining that at least one of the items in the purchase order of stage 104 is marked as expecting a goods receipt, the procurement management system may search for the corresponding expected goods receipt, for example, in an appropriate list, database, or any other suitable storage to which the procurement management system has access. As a result of the search, the procurement management system may determine that no goods receipt exists or is otherwise acknowledged in connection with the one or more items marked as expecting goods receipts at stage 106.

Based on the determination at stage 106, the procurement management system may prevent entry of the invoice, which the user has initiated at stage 102, or at least prevent entry of the marked item associated with the missing goods receipt in the invoice, at stage 108. The procurement management system may prevent the invoice entry, for example, by preventing the user from accessing an invoice entry screen or by using any other suitable means.

In the above procurement management system, total prevention of invoice entry may be restricted to those situations in which no goods receipt is found for any of the items that were marked as expecting goods receipts in the purchase order. In a situation where goods receipts are found for some of the marked items while no goods receipts were located for some other marked items in the purchase order, the procurement management system may allow entry of only those marked items having corresponding goods receipts in the invoice. In addition, the procurement management system may suggest invoice information, including item name, quantity, etc., for those marked items having corresponding goods receipts. No suggestion may be made for those marked items with missing goods receipts and the user may be prevented from manually input these marked items having missing goods receipts into the invoice.

It is apparent from the above description that invoice entry in connection with a purchase order may be completely prevented, for example, if all the marked items in the purchase order are missing their corresponding goods receipts. As an example, if a purchase order includes ten items marked for goods receipts and no goods receipt is found for any of the ten items, the procurement management system may prevent creation of an invoice for the purchase order altogether. From this example, it is easy to see the disadvantages of the above broad rule of invoice entry prevention, especially considering that the goal of the prevention is simply to prevent posting of the invoice for financial processing, not necessarily to prevent the mere entry of the items in an invoice.

In addition, even in situations where the above procurement management system permits the entry of the invoice, for example, when at least one of the marked item in the related purchase order has a corresponding goods receipt, the procurement management system may prevent entry of those marked items having missing goods receipts in the invoice, even when information for making such entries may be readily obtained from the related purchase order. Thus, the known procurement management system severely restricts the user's ability to enter invoices when items in a purchase order related to the invoice are marked as expecting good receipts and the expected goods receipts are not found or otherwise acknowledged by the procurement management system.

### SUMMARY OF THE INVENTION

Consistent with the principles of the present invention, a system and method is disclosed for processing an invoice entry in a procurement management system, where the invoice entry includes an item that is missing its expected goods receipts.

Upon receiving entry of an invoice, the procurement management system may determine that a first item in a purchase order associated with the invoice is marked as expecting a first goods receipt. The procurement management system may also determine that the first goods receipt does not exist in connection with the first item. Based on these determinations, the procurement management system may suggest information for insertion into the invoice for the first item based on information in the purchase order.

Consistent with the principles of the present invention, the procurement management system may further determine that a second goods receipt exists in connection with a second item marked as expecting the second goods receipt in the purchase order. In response to this determination, the procurement management system may suggest information for insertion into the invoice for the second item based on a combination of information in the purchase order and in the second goods receipt.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this disclosure, illustrate various systems and aspects consistent with the principles of the invention. In the drawings:

FIG. 1 is a flowchart of invoice entry in a known procurement management system.

FIG. 2 is a flowchart of invoice entry in a procurement management system consistent with the principles of the invention.

FIG. 3 is an interface for purchase order entry in a procurement management system consistent with the principles of the invention.

FIG. 4 is an interface for invoice entry in a procurement management system consistent with the principles of the invention.

FIG. 5 is an illustrative computer system for implementing a software application consistent with the principles of the invention.

FIG. 6 is another illustrative computer system for implementing a software application consistent with the principles of the invention.

### DETAILED DESCRIPTION

The following detailed description refers to the accompanying drawings. Wherever possible, the same reference numbers are used in the drawings and the following description to refer to the same or similar parts. While several exemplary versions and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding stages to the disclosed methods. Accordingly, the following detailed description does not limit the invention. Instead, the proper scope of the invention is defined by the appended claims.

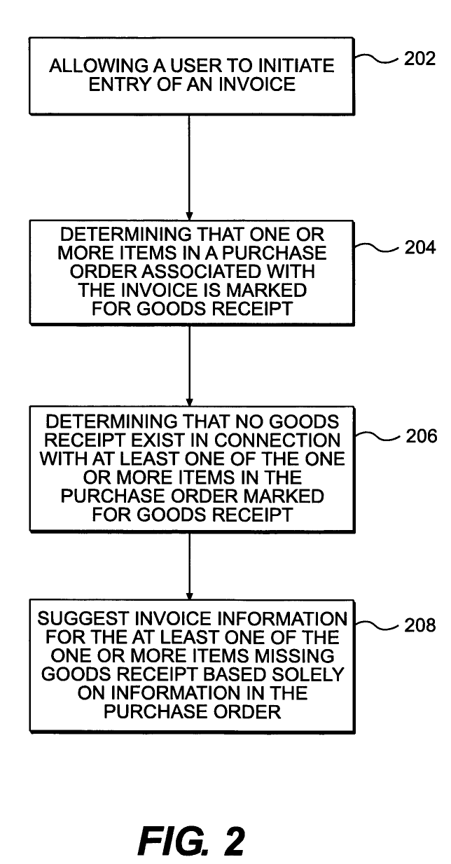

A procurement management system consistent with the principles of the invention improves upon the known procurement management system by allowing invoice entry regardless of whether any goods receipts that are expected in connection with one or more marked items in the invoice have been received or acknowledged. Illustrative stages involved in providing such unrestricted invoice entry consistent with the principles of the invention are shown in FIG. 2.

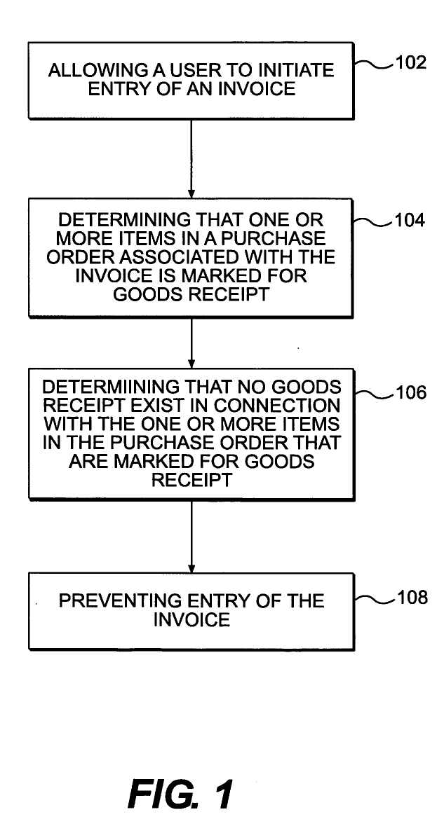

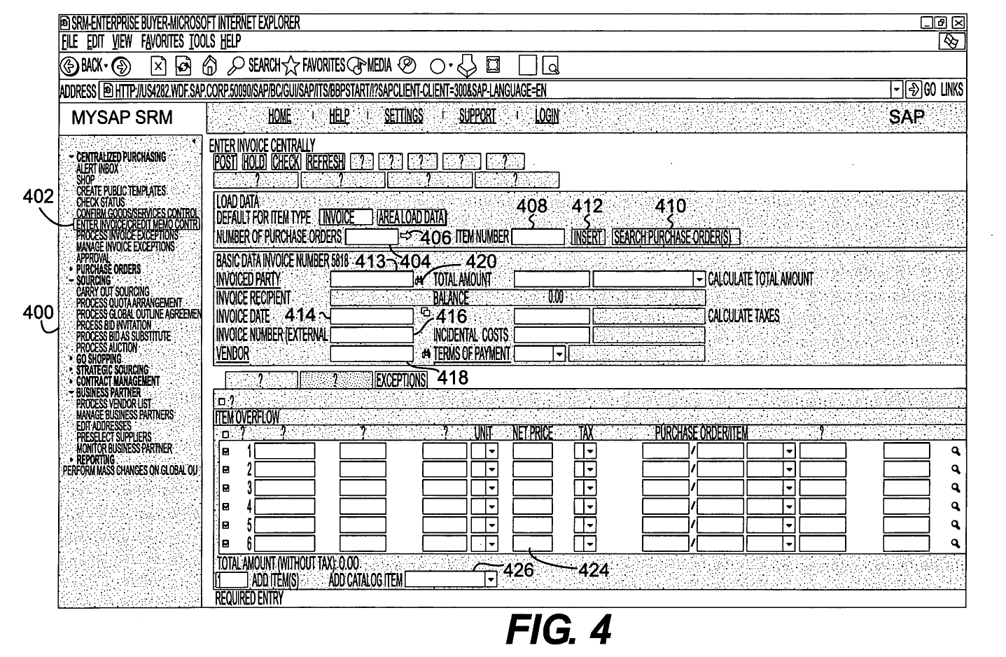

FIG. 2 is a flowchart of invoice entry in a procurement management system consistent with the principles of the invention. In FIG. 2, stages 202 and 204 may be very similar to stages 102 and 104 of FIG. 1. At stage 202, the procurement management system may allow the user to initiate entry of an invoice, for example, by selecting an invoice entry option such as option 402 of FIG. 4 in one or more interfaces, or by using any other suitable means. In response to the user selecting such an option, the procurement management system may provide the user with an interface, such as interface 400 of FIG. 4, for inputting the invoice entry.

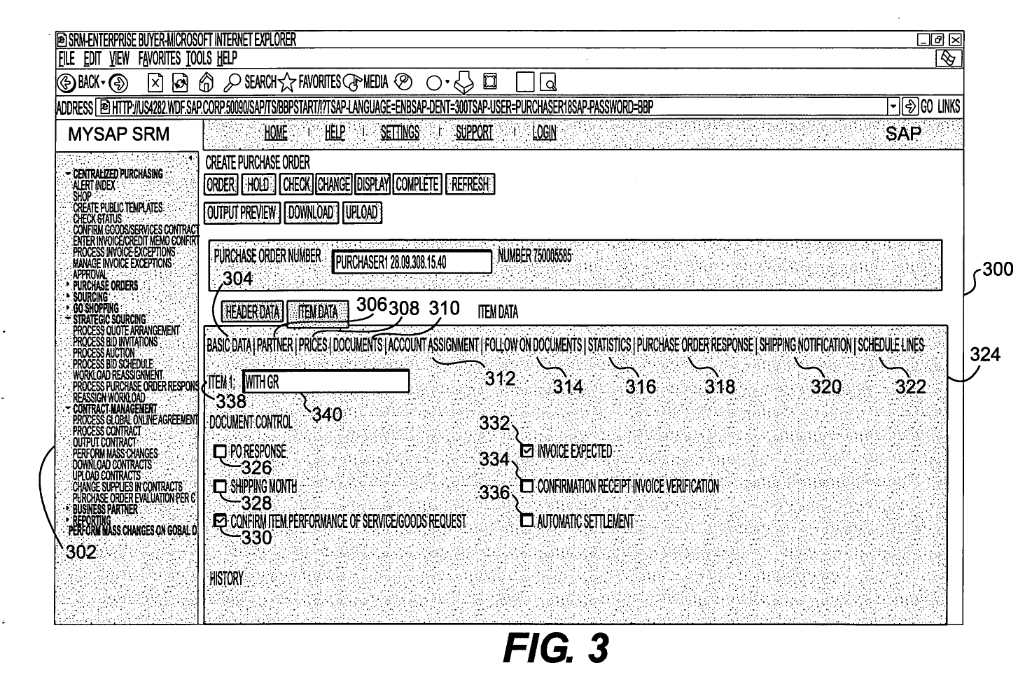

At stage 204, the procurement management system may determine that one or more items in a purchase order related to the present invoice entry are marked as expecting goods receipts. The one or more items of the related purchase order may have became marked as expecting goods receipts, for example, in response to suitable user selections during entry of the purchase order, as shown in FIG. 3. Any other suitable methods may be used to mark one or more items in the related purchase order as expecting goods receipts, including automatically marking the items as a stage in the invoice processing procedure by the procurement management system, without departing from the spirit of the present invention. The procurement management system may determine that one or more items in the purchase order are marked for goods receipts, for example, based on flags or any other suitable indicators, which may be stored in connection with the marked items and/or the goods receipts, for example, in a suitable database.

At stage 206, the procurement management system may determine that at least one of the one or more marked items in the related purchase order are missing their expected goods receipts. The procurement management system may make this determination, for example, by performing a search in an appropriate database or any other suitable storage to which the procurement management system has access, and in which the goods receipts and/or their relationships with one or more marked items in the related purchase order are indicated.

As an example, when a goods receipt corresponding to a marked item in a purchase order is entered into the procurement management system, a flag or other suitable mechanism may be generated and may be associated with the goods receipt, the corresponding marked item, or both to indicate that the marked item is now associated with its expected goods receipt. Any other suitable mechanism or method may be used to indicate the existence of a corresponding goods receipt to a marked item of a purchase order without departing from the spirit of the present invention.

At stage 208, the procurement management system may suggest invoice information for those marked items in the related purchase order that have been determined as missing their expected goods receipts. Because information in connection with these items may not be obtained or verified against their missing goods receipts, the information suggested by the procurement management system may be obtained exclusively from the related purchase order. On the other hand, for those marked items that have been determined as having their corresponding goods receipts at stage 206, the procurement management system may obtain and verify information associated with these items from and against both the related purchase order and the items' corresponding goods receipts.

Consistent with stage 208, the procurement management system may provide suggestions of invoice information for all marked items of a related purchase order regardless of whether their expected goods receipts exist. While data suggestions in connection with those marked items that are missing goods receipts may be less reliable, due to being derived from a single source, for example, the related purchase order, without being further verified against any related goods receipts, these data suggestions nonetheless provide the user with a suitable basis for at least making entries for those marked items in the invoice.

In some systems consistent with the principles of the invention, the procurement management system may additionally allow the user to manually input item information in the invoice entry without any data suggestion by the procurement management system based on any related purchase order, goods receipt, or any other suitable related document. In this way, the procurement management system allows the user the flexibility and provides the user with the ultimate control in determining which items to include in an invoice. In some systems consistent with the principles of the invention, the user may additionally modify and/or delete any suggestions made by the procurement management system.

FIG. 3 shows an illustrative purchase order entry interface consistent with the principles of the invention. As briefly mentioned above, a purchase order is generally created during the initial phases of a procurement transaction when goods or services are requested from a vendor or service provider. The user may initiate entry of a purchase order in the procurement management system by, for example, selecting a purchase order option, such as purchase order option 302, in one or more interfaces.

In response to the user requesting to make a purchase order entry, the procurement management system may provide a purchase order entry interface, such as interface 300, in which various data associated with the purchase order may be entered. One type of data to be entered may be item data, which may include any suitable information associated with those items requested from the vendor or service provider. In some systems consistent with the principles of the invention, item data may be separately grouped into various sub-categories in interface 300. In the present example, various tabs 304-322 are provided to enable the user to access, input, and otherwise interact with the sub-categories of item data, for example, in different tables displayed on interface 300. As an example, basic data tab 304 may provide access to such information as item name, description, etc. Partner tab 306 may enable interactions with data associated with the one or more partners involved in the purchase order, including, for example, a vendor, a service provider, etc.

In the present example, the tab follow-on documents 314 have been selected. A follow-on document may refer to any document that may be generated subsequent to and in connection with a purchase order, including a response to a purchase order, a shipping notification, an invoice, a goods receipt or other suitable confirmation, a settlement document, and/or any other suitable subsequent related document of a purchase order.

In some systems consistent with the principles of the invention, at the time of purchase order entry, the procurement management system may allow the user to indicate any subsequent actions that may be expected with respect to any follow-on documents. In the present example, the user may select such actions, for example, from a list in which the available actions are associated with corresponding checkboxes 326-336. In some systems consistent with the principles of the invention, certain actions with respect to follow-on documents may be closely related and may be required in combination.

As an example, the option confirm performance of goods receipt 330 is selected in table 324. In response to the user selecting this option, the procurement management system may additionally require that another option, confirmation-related invoice verification, be performed in combination with the selected option. The procurement management system may indicate this additional requirement, for example, by automatically selecting the invoice verification option 334. Furthermore, the procurement management system may make automatically selected option 334 inactive or otherwise non-modifiable, thereby prevent the user from altering the required combination. It will be understood that any other suitable selection mechanisms may be used and any other suitable actions may be selected with respect to the follow-on documents without departing from the spirit of the present invention.

In some systems consistent with the principles of the invention, the procurement management system may further allow the user to indicate if separate goods receipts are to be expected in connection with individual items in the purchase order. In the present example, an item 338 of the purchase order is listed in table 324. An input or selection mechanism 340 may be provided in connection with the listed item 338, through which the user may indicate, for example, that a separate goods receipt is expected for that item. Such a selection may turn the listed item into a marked item, which is expecting a corresponding goods receipt as discussed above. In response to this selection, the procurement management system may perform the checks and verifications, for example, as described above in connection with FIG. 2, when processing invoice entries. It will be understood that goods receipt may be required by the user for none, some, or all of the items in the purchase order without departing from the spirit of the present invention.

FIG. 4 is an exemplary invoice entry interface 400 in which invoice information associated with items in a related purchase order may be suggested consistent with the principles of the invention. As mentioned above, an invoice input entry interface, such as interface 400 may be provided, for example, in response to the user requesting invoice entry by selecting an option such as option 402 in one or more interfaces of the procurement management system.

A load data section 402 may be provided in interface 400. In this section, the user may insert items into the invoice, for example, by obtaining data suggestions associated with the items from one or more related documents in the procurement management system. The related documents may be, for example, a purchase order, a goods receipt, a related invoice, or any other suitable document. In the present example and as mentioned above in connection with FIG. 2, the user may obtain item data suggestions from a number of existing related purchase orders. For example, the user may provide a known purchase order number of a related purchase order in field 404. The user may obtain this number, for example, from a received invoice, which may reference the purchase order. The user may press button 406 to display a new screen or interface in which the user may enter or select multiple purchase orders, for example, using a mechanism for multiple selection.

In the event that the user does not know the specific purchase order number of one or more related purchase order, the user may request a general search for the one or more related purchase order using, for example, the find purchase order option 410. In connection with this option, the user may use various criteria, such as a vendor, an invoicing party, or any other suitable criteria, to search for a related purchase order.

In the present example, the user may insert the selected item from the purchase order into the present invoice entry using insert button 412. Insertion of the item may involve a data suggestion by the procurement management system as described in connection with FIG. 2. As a part of the data suggestion process, the procurement management system may determine if the selected item to be inserted into the invoice is marked as expecting a corresponding goods receipt, for example, when the related purchase order is first inputted, as shown in FIG. 3.

If the selected item is determined as being marked as expecting a goods receipt, the procurement management system may proceed to determine if the expected goods receipt exists. If the corresponding goods receipt is found, the procurement management system may suggest item information based on a combination of the purchase order and goods receipt for insertion into the invoice. For example, the procurement management system may verify that item information, such as price, quantity, etc., match between the purchase order and the goods receipt. Any other suitable process for suggesting data for the invoice item based on a combination of a related purchase order and goods receipt may be implemented without departing from the spirit of the present invention. If, however, the procurement management system determines that the selected item is marked as expecting a corresponding goods receipt, but the goods receipt does not exist, the procurement management system may simply suggest item data obtained solely from the related purchase order for insertion into the invoice.

While data loading from related documents such a purchase order is specifically described above, it is not the only way to input item data into an invoice. The user may manually input various invoice and item data or use any other suitable input means for entering such data without departing from the spirit of the present invention. For example, data may be manually entered into various fields of the invoice entry interface of FIG. 4, including fields invoicing party 413, invoice date 414, external invoice number 416, vendor 418, and a number of other suitable types of information. In the present example, the user may also use a search function such as search button 420 to select invoice input including an invoicing party from, for example, a list, a database, or any other suitable storage to which the procurement management system has access.

When inputting data in interface 400, certain types of information may be prevented from user modification, for example, to prevent manual entry errors or unauthorized data manipulation. Prevention of user modification may be achieved by, for example, making the data field inactive or by using any other suitable method. In the present example, the field invoice recipient 422 is made inactive. This may prevent an unauthorized user from making modification to this field. An inactive field or other such restricted information may be made available for modification, for example, when the user is identified as an authorized user for making such modifications.

In portion 424 of screen 400, an overview of the various items included in the invoice may be displayed. Some attributes of each of the items, including, for example, a description, a net value, quantity, net price, tax, etc. may be displayed. Item overview 424 may list those inserted items having suggested data from a related purchase order and/or goods receipt as described above in connection with FIG. 2. In some systems consistent with the principles of the invention, the user may manually add or modify data associated with the items using the provided input means (e.g., text boxes and drop down menus). Alternatively, the user may choose to add an item and its associated data from a stored catalog by, for example, selecting the item from catalog 426. It will be understood that invoice entry interface 400 is merely illustrative of such an interface. Any other suitable screens or interfaces may be used without departing from the spirit of the present invention.

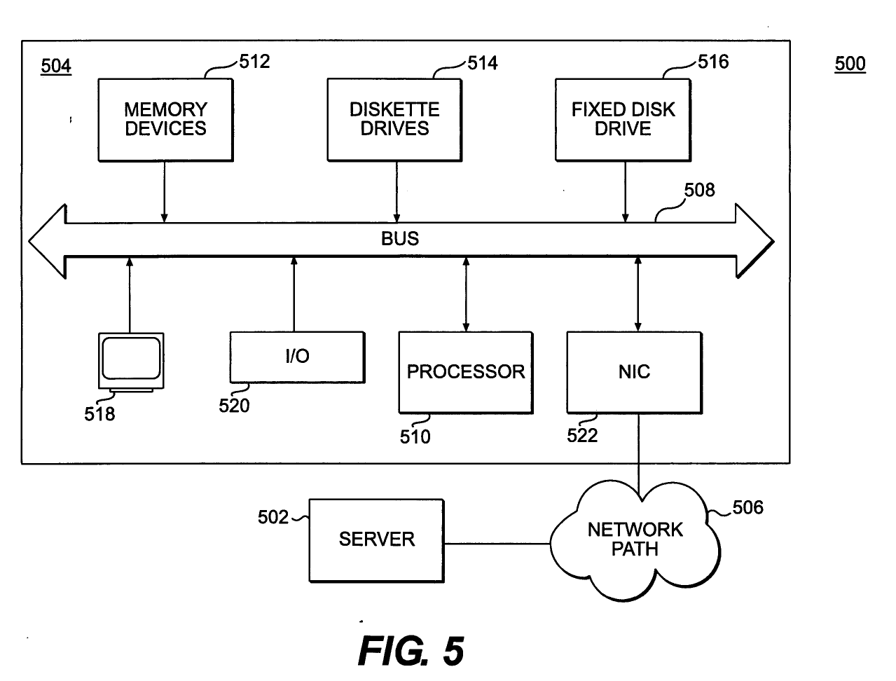

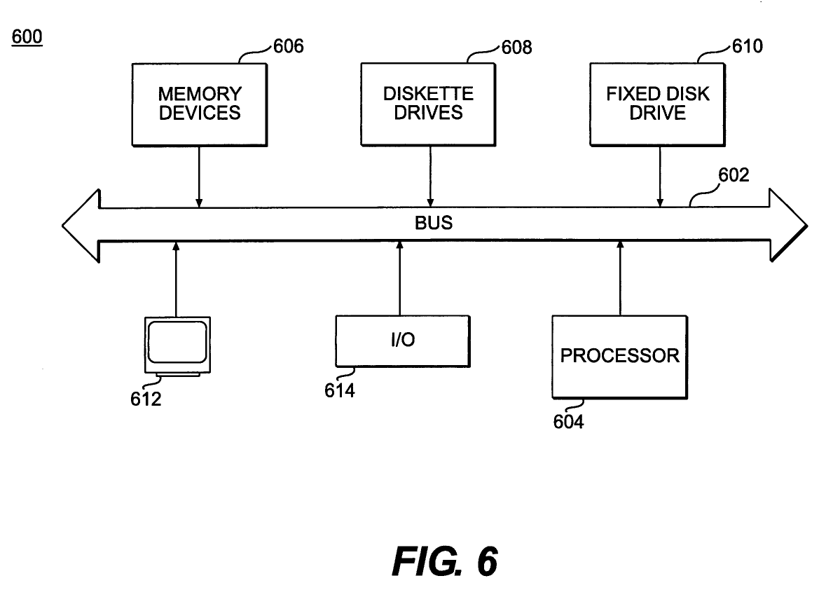

A computer system may be used for implementing a system and method of invoice entry as described herein. The computer system may be a computer network, as shown in FIG. 5, or a stand-alone personal computer (PC), as shown in FIG. 6.

As shown in FIG. 5, a computer network 500 consistent with the principles of the present invention may include a server 502 and a stand-alone PC 504 connected through a network path 506. Computer network 500 may be a local area network (LAN), where server 502 and PC 504 are workstations. Computer network 500 may also be the Internet, with server 502 hosting a web application and PC 504 being any workstation available to a user desiring to interface with the application on server 502. Alternatively, computer network 500 may be a wide area network (WAN), and server 502 and PC 504 may lie in two separate LANs connected through the Internet.

PC 504 may include a bus line 508 connecting a plurality of devices such as a processor 510, memory devices 512 for storage of information, diskette drives 514, a fixed disk drive 516, a monitor or display 518, other I/O devices 520, and a network interface card (NIC) 522. Processor 510 may be a microprocessor such as an Intel Pentium™ chip for processing applications. Memory devices 512 may include read-only memories (ROM) and/or random access memories (RAM). Diskette drives 514 may include a floppy drive and/or a compact disk (CD) drive. Fixed disk drive 516 may be a hard drive. I/O devices 520 may include a keyboard and/or a mouse for receiving input from a user of PC 504. Monitor or display 518 may display output from processor 510, and may also echo the input of the user. PC 504 may be connected to network path 506 through NIC 522.

A web application may be installed on server 502. An individual desiring to enter data into the application on server 502 may use a web browser loaded on PC 504, and may communicate with server 502 through NIC 522 and network path 506. In one aspect, software application for implementing a system consistent with the principles of the invention may be stored in PC 504 and processor 510 of PC 504 may execute the software application locally within PC 504 and interface with a web application on server 502. Particularly, the software application may be stored on a floppy disk, a CD, or any other suitable readable media, which may be accessible by diskette drive 514, fixed disk drive 516, or any other suitable mechanism. In another aspect, the software application for implementing a system consistent with the principles of the invention may be stored in server 502, which may execute the software application, and processor 510 of PC 504 may communicate with server 502 to send information to server 502 and retrieve the results of the execution of the software application from server 502.

Through the execution of the software application implementing a system consistent with the principles of the invention, either locally within PC 504 or remotely within server 502, an interface may be provided on a user display, which enables the user to input, view, and interact with an invoice having one or more line items of different line item types.

Alternatively, as shown in FIG. 6, a stand-alone PC 600 may be used for implementing a software application implementing a system consistent with the principles of the invention. PC 600 may include a bus line 602 connecting a plurality of devices, which may include a processor 604, memory devices 606 for storage of information, diskette drives 608, a fixed disk drive 610, a monitor or display 612, and other I/O devices 614. Processor 604 may be a microprocessor such as an Intel Pentium™ chip for processing applications. Memory devices 606 may include ROM and/or RAM. Diskette drives 608 may include a floppy drive and/or a compact disk (CD) drive. Fixed disk drive 610 may be a hard drive. Monitor or display 612 may display the output of processor 604 and may also echo the input of the user. I/O devices 614 may include a keyboard and/or a mouse for receiving input from a user of PC 600.

A software application implementing a system consistent with the principles of the invention may be stored on a floppy disk or a CD accessible by diskette drive 608 or on fixed disk drive 610. Processor 604 may execute the software application stored in the floppy disk the CD or the fixed disk drive 610. An individual, through monitor or display 612 and I/O devices 614, may interact with processor 604, which may execute the software application. A software application implementing a system consistent with the principles of the invention may be written in any number of programming languages, including but not limited to JavaScript, Visual Basic, Flash, ABAP coding, or any other suitable language. Similarly, the present invention is not limited to use with certain applications, Internet browsers or operating systems.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

While the present invention has been described in connection with various systems consistent with the principles of the invention, many modifications will be readily apparent to those skilled in the art. One skilled in the art will also appreciate that all or part of the systems and methods consistent with various systems consistent with the principles of the invention may be stored on or read from computer-readable media, such as secondary storage devices, like hard disks, floppy disks, and CD-ROM; a carrier wave received from a network such as the Internet; or other forms of ROM or RAM. Accordingly, systems consistent with the principles of the invention of the invention are not limited to the above described systems and examples, but instead is defined by the appended claims in light of their full scope of equivalents.

What is claimed is:

1. A method comprising:
receiving entry of an invoice;
determining that a first item in a purchase order associated with the invoice is marked as expecting a first goods receipt;
determining that the first goods receipt does not exist in connection with the first item; and
suggesting information for insertion into the invoice for the first item based on information in the purchase order.

2. The method of claim 1, wherein the method further comprises determining that a second goods receipt exists in connection with a second item marked as expecting the second goods receipt in the purchase order.

3. The method of claim 2, wherein the method further comprises suggesting information for insertion into the invoice for the second item based on a combination of information in the purchase order and in the second goods receipt.

4. A system comprising:
an I/O device; and
a processor configured to:
receive entry of an invoice from the I/O device;
determine that a first item in a purchase order associated with the invoice is marked as expecting a first goods receipt;
determine that the first goods receipt does not exist in connection with the first item; and
suggest information for insertion into the invoice for the first item based on information in the purchase order.

5. The system of claim 4, wherein the processor is further configured to determine that a second goods receipt exists in connection with a second item marked as expecting the second goods receipt in the purchase order.

6. The system of claim 5, wherein the processor is further configured to suggest information for insertion into the invoice for the second item based on a combination of information in the purchase order and in the second goods receipt.

7. A computer-readable medium including instructions for performing, when executed by a processor, a method comprising:
receiving entry of an invoice;
determining that a first item in a purchase order associated with the invoice is marked as expecting a first goods receipt;
determining that the first goods receipt does not exist in connection with the first item; and
suggesting information for insertion into the invoice for the first item based on information in the purchase order.

8. The computer-readable medium of claim 7 further includes instructions for determining that a second goods receipt exists in connection with a second item marked as expecting the second goods receipt in the purchase order.

9. The computer-readable medium of claim 8 further includes instructions for suggesting information for insertion into the invoice for the second item based on a combination of information in the purchase order and in the second goods receipt.
